(19) United States
(12) Patent Application Publication
(10) Pub. No.: US 2025/0146573 A1
(43) Pub. Date: May 8, 2025

(54) Liquid Tight Gasket Assembly

(71) Applicant: Daniele La Posta, Medford, MA (US)

(72) Inventor: Daniele La Posta, Medford, MA (US)

(21) Appl. No.: 18/387,560

(22) Filed: Nov. 7, 2023

(51) Int. Cl. F16J 15/10

(52) U.S. Cl. CPC F16J 15/104

(57) ABSTRACT

A liquid tight gasket assembly for use in creating a liquid tight seal for one or more fasteners that pass through holes in a hollow body, with an outside plate configured to be attached to one side of the hollow body and having one or more holes configured to allow fasteners to pass through, a conformable gasket that is generally flat on top with a truncated cone on the bottom, wherein the gasket has a central opening with a diameter slightly smaller than a diameter of a stem of the fastener to pass through it, wherein the cone has a height that is longer than the thickness of the hollow body at the hole where the cone is inserted, and wherein the cone has a largest diameter that is greater than the diameter of the hole where the cone is inserted, so that the gasket does not enter the hole completely without a deforming force being applied, an inside plate configured to be attached to a second side of the hollow body directly opposed to the outside plate and having one or more holes configured to allow fasteners to pass through, and fasteners with external male threads and having a stem diameter slightly larger than the diameter of the opening in the gasket. The fasteners are configured to pass through the outside plate, through the gasket center hole, and through the inside plate. There are nuts or other internally-threaded structures that are configured to be threaded onto the stem of a fastener protruding from the inside plate, wherein the action of threading the nuts or other internally-threaded structures firmly onto the stems exerts a compressing force between the outside and inside plates, thus forcing the cone completely inside the hole and against the stem, creating a liquid seal from the outside to the inside of the hollow body, and wherein the flat part of the gasket is compressed between the outside plate and the hollow body surface thus contributing to prevent liquid infiltration.

### BACKGROUND

This disclosure relates to a watertight gasket assembly.

There are many situations in which a device or assembly, such as a handle or a latch, needs to be attached to another device via holes in the other device. If the other device is to be used in or on or exposed to water or other liquids, the holes are a potential source of liquid infiltration. There is thus a need for a gasket assembly that can maintain a liquid-tight environment despite the hole(s) in the other device.

### SUMMARY

Aspects and examples are directed to a liquid tight gasket assembly (LTGA) that helps to create a strong, non-flexible liquid tight latch/keeper (or other device) attachment system to a hollow body that needs to operate in a wet environment without allowing water/liquid to enter the hollow body through the device mounting holes in the hollow body. In some examples the LTGA includes an outside plate that is to be attached to a hollow body with one or more holes to let a bolt or other fastener pass through. There is a purpose-made flexible/compressible (e.g., rubber or elastomer) gasket that is in some examples flat on top with a truncated cone on the bottom. The gasket has a central longitudinal opening or center hole with a diameter slightly smaller than the bolt stem to be threaded in it. In some examples the height or length of the cone portion of the gasket is slightly longer than the thickness of the pre-drilled hole where it is inserted. Pre-drilled holes in the surface of the hollow body device (e.g., a stand-up paddleboard) have a diameter that is slightly smaller than the cone's larger diameter, so that the gasket does not enter the hole completely without force. There is an inside plate, with at least one (or more) drilled holes, whose diameter is sufficient to allow the bolt stem to pass through, to be mounted from inside the hollow body. The stem diameter of the bolt is slightly larger than the diameter of the central opening of the gasket.

After drilling pre-set holes of pre-determined diameters, at pre-marked locations, the gaskets are inserted in each hole. The bolt(s), after passing through the outside plate, are threaded through the gasket center hole. The inside plate, with one or more pre-drilled holes, gets mounted from inside the module allowing the bolt stems protruding from the pre-drilled holes to enter the respective hole before nuts are threaded on them. The action of threading the nuts firmly on the bolts exerts a compressing force between the two plates, thus forcing the rubber cone completely inside the pre-drilled hole (and against the bolts) creating a watertight environment. The flat part of the rubber gasket also gets compressed between the outside plate and the hollow body surface thus contributing to prevent water filtration.

In some examples the hollow body is made of two or more separate portions that are coupled together before the hollow body is used. One non-limiting example is the stand-up paddleboard (SUP) disclosed in publication 2021/0394871, the entire disclosure of which is incorporated by reference herein, and for all purposes. This SUP is made of three hollow modules that are interconnected by interior releasable latching mechanisms that use a pin and receiving assembly arrangement, with the pin moved by a handle. The two joints between the three modules can be stiffened by the use of releasable latch assemblies on the top and bottom surfaces, where the latch assemblies have a latch on one module and a receiver or keeper on the adjoining module. The latch can be an over-center latch of a type known in the latch field. In one example each latch is held in place with three bolts and each keeper is held in place with two bolts. There can be two latch assemblies on the top of the SUP, one for each of the two joints, with the same arrangement on the bottom of the board. Thus, four latches in total, meaning twenty holes drilled into an otherwise water-tight molded module portion of the SUP. Each of these holes can be made liquid tight using the gasket assemblies disclosed herein.

All examples and features mentioned below can be combined in any technically possible way.

In one aspect, a liquid tight gasket assembly for use in creating a liquid tight seal for one or more fasteners that pass through holes in a hollow body has an outside plate configured to be attached to one side of the hollow body and having one or more holes configured to allow fasteners to pass through, a conformable gasket that is generally flat on top with a truncated cone on the bottom, wherein the gasket has a central opening with a diameter slightly smaller than a diameter of a stem of the fastener to pass through it, wherein the cone has a height that is longer than the thickness of the hollow body at the hole where the cone is inserted, and wherein the cone has a largest diameter that is greater than the diameter of the hole where the cone is inserted, so that the gasket does not enter the hole completely without a deforming force being applied, an inside plate configured to be attached to a second side of the hollow body directly opposed to the outside plate and having one or more holes configured to allow fasteners to pass through, and fasteners with external male threads and having a stem diameter slightly larger than the diameter of the opening in the gasket. The fasteners are configured to pass through the outside plate, through the gasket center hole, and through the inside plate. There are nuts or other internally-threaded structures that are configured to be threaded onto the stem of a fastener protruding from the inside plate, wherein the action of threading the nuts or other internally-threaded structures firmly onto the stems exerts a compressing force between the outside and inside plates, thus forcing the cone completely inside the hole and against the stem, creating a liquid seal from the outside to the inside of the hollow body, and wherein the flat part of the gasket is compressed between the outside plate and the hollow body surface thus contributing to prevent liquid infiltration.

Some examples include one of the above and/or below features, or any combination thereof. In an example the gasket is made of rubber or an elastomer. In an example the hollow body comprises part of a watercraft. In an example the hollow body comprises part of a stand up paddleboard. In an example the outside plate comprises the base of a latch. In an example the outside plate comprises the base of a keeper.

### BRIEF DESCRIPTION OF THE DRAWINGS

Various aspects of at least one example are discussed below with reference to the accompanying figures, which are not intended to be drawn to scale. The figures are included to provide illustration and a further understanding of the various aspects and examples and are incorporated in and constitute a part of this specification but are not intended as a definition of the limits of the inventions. In the figures, identical or nearly identical components illustrated in various figures may be represented by a like reference character or numeral. For purposes of clarity, not every component may be labeled in every figure. In the figures:

FIG. 1A is a cross-sectional view of a liquid tight gasket assembly before it is tightened/compressed;

FIG. 1B is a cross-sectional view of the liquid tight gasket assembly of FIG. 1A after it is tightened/compressed;

FIG. 2 is a schematic cross-sectional view of an engaged latch and keeper assembly using two of the liquid tight gasket assemblies of FIGS. 1A and 1B; and

FIG. 3 is a partial top unassembled view of a three-part standup paddleboard configured to use the liquid tight gasket assemblies and the latch and keepers as depicted in FIGS. 1A, 1B, and 2.

### DETAILED DESCRIPTION

Examples of the systems, methods and apparatuses discussed herein are not limited in application to the details of construction and the arrangement of components set forth in the following description or illustrated in the accompanying drawings. The systems, methods and apparatuses are capable of implementation in other examples and of being practiced or of being carried out in various ways. Examples of specific implementations are provided herein for illustrative purposes only and are not intended to be limiting. In particular, functions, components, elements, and features discussed in connection with any one or more examples are not intended to be excluded from a similar role in any other examples.

Examples disclosed herein may be combined with other examples in any manner consistent with at least one of the principles disclosed herein, and references to “an example.” “some examples,” “an alternate example,” “various examples,” “one example” or the like are not necessarily mutually exclusive and are intended to indicate that a particular feature, structure, or characteristic described may be included in at least one example. The appearances of such terms herein are not necessarily all referring to the same example.

Also, the phraseology and terminology used herein is for the purpose of description and should not be regarded as limiting. Any references to examples, components, elements, acts, or functions of the products, systems and methods herein referred to in the singular may also embrace embodiments including a plurality, and any references in plural to any example, component, element, act, or function herein may also embrace examples including only a singularity. Accordingly, references in the singular or plural form are not intended to limit the presently disclosed systems or methods, their components, acts, or elements. The use herein of “including,” “comprising.” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

In the embodiment shown in the drawings the WTGA helps to create a strong, non-flexible liquid tight latch/keeper attachment system to a multi-part SUP or other hollow body that needs to operate in a wet environment without allowing water/liquid to enter the hollow body through the device mounting holes in the hollow body. In the disclosed example the WTGA includes an outside plate that is to be attached to the hollow body with one or more holes to let a bolt or other fastener pass through. There is a purpose-made flexible (e.g., rubber) gasket that is flat on top with a truncated cone on the bottom. The gasket has a central longitudinal opening or center hole with a diameter slightly smaller than the bolt stem to be threaded in it. The height or length of the cone portion of the gasket is slightly longer than the thickness of the pre-drilled hole where it is inserted. Pre-drilled holes in the surface of the hollow body device have a diameter that is slightly smaller than the cone's larger diameter, so that the gasket does not enter the hole completely without force. There is an inside plate, with at least one (or more) drilled holes, whose diameter is sufficient enough to allow the bolt stem to pass through, to be mounted from inside the hollow body. The stem diameter of the bolt is slightly larger than the diameter of the central opening of the gasket.

After drilling pre-set holes of pre-determined diameters, at pre-marked locations the gaskets are inserted in each hole. The bolt(s), after passing through the outside plate, are threaded through the gasket center hole. The inside plate is mounted from inside the module, allowing the bolt stems protruding from the pre-drilled holes to enter the respective hole before nuts are threaded on them. The action of threading the nuts firmly on the bolts exerts a compressing force between the two plates, thus forcing the rubber cone completely inside the pre-drilled hole (and against the bolts) creating a watertight environment. The flat part of the rubber gasket also gets compressed between the outside plate and the hollow body surface thus contributing to prevent water filtration.

In some examples the hollow body is made of two or more separate portions that are coupled together before the hollow body is used. One non-limiting example is the stand-up paddleboard (SUP) disclosed in publication 2021/0394871. This SUP is made of three hollow modules that are interconnected by interior releasable latching mechanisms that use a pin and receiving assembly arrangement, with the pin moved by a handle. The two joints between the three modules can be stiffened by the use of releasable latch assemblies on the top and bottom surfaces, where the latch assemblies have a latch on one module and a receiver or keeper on the adjoining module. The latch can be an over-center latch of a type known in the latch field. In one example each latch is held in place with three bolts and each keeper is held in place with two bolts. There can be two latch assemblies on the top of the SUP for each of the two joints, and three on the bottom. Thus, ten in total, meaning fifty holes drilled into an otherwise water-tight molded module. Each of these holes can be made liquid tight using the gasket assemblies disclosed herein.

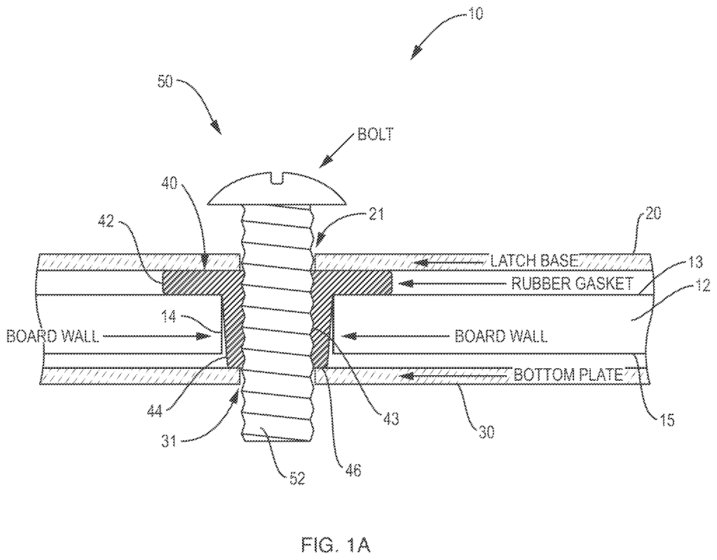

FIG. 1A is a cross-sectional view of a liquid tight gasket assembly 10 before it is tightened/compressed, and FIG. 1B is a cross-sectional view of the liquid tight gasket assembly of FIG. 1A after it is tightened/compressed. Assembly 10 helps to create a strong, non-flexible liquid tight latch/keeper attachment system to a multi-part SUP or other hollow body that needs to operate in a wet environment without allowing water/liquid to enter the hollow body through the device mounting holes in the hollow body. Another non-limiting example might be mounting a handle to the outside of a liquid container.

In the disclosed example assembly 10 includes an outside plate 20 that is to be attached to the hollow body with one or more holes (e.g., hole 21) to let a bolt or other fastener 50 pass through. There is a purpose-made flexible (e.g., rubber or elastomeric) gasket 40 that has a flat top portion 42 with a truncated cone 44 on the bottom. The gasket has a central longitudinal opening or center hole 43 with a diameter slightly smaller than the male threaded stem 52 of bolt 50. The height or length of the cone portion of the gasket is slightly longer than the thickness of the pre-drilled hole where it is inserted.

The pre-drilled hole 14 in the surface of the hollow body device has a diameter that is slightly smaller than the cone's largest diameter where it meets flat portion 42, so that the gasket does not enter the hole completely without force. There is an inside plate 30, with at least one (or more) drilled holes 31, whose diameter is sufficient enough to allow the bolt stem to pass through, to be mounted from inside the hollow body. The stem diameter of the bolt is slightly larger than the diameter of the central opening 43 of the gasket.

After drilling pre-set holes of pre-determined diameters, at pre-marked locations the gaskets are inserted in each hole. The bolt(s), after passing through the outside plate, are threaded through the gasket center hole. The inside plate is mounted from inside the module, allowing the bolt stems 52 protruding from the pre-drilled holes to enter the respective hole before nuts 60 (e.g., nyloc nuts) are threaded on them. The action of threading the nuts firmly on the bolts exerts a compressing force between the two plates 20 and 30, thus forcing the rubber cone 44 completely inside the pre-drilled hole 14 (and against the bolt stem 52), creating a watertight environment. In other words, the portion of gasket cone 44 that protrudes below lower module surface 15 gets pushed up into hole 14 and the larger diameter top of cone 44 gets pushed down into hole 14. Since the top 42 of the gasket is constrained by plate 20, this causes the gasket material to deform and fill hole 14 and seal against the threads of bolt stem 52. The flat part 42 of the rubber gasket also gets compressed between the outside plate 20 and the top surface 13 of hollow body surface thus contributing to prevent water infiltration through hole 14.

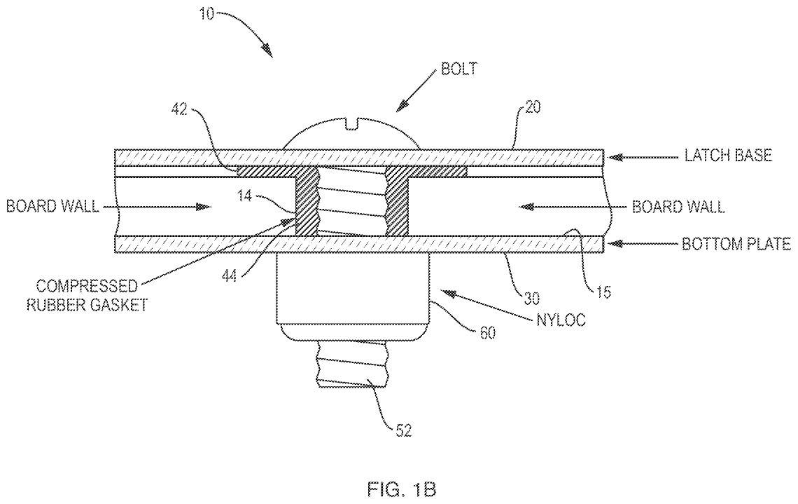

FIG. 2 is a schematic cross-sectional view of an engaged latch and keeper assembly using two of the liquid tight gasket assemblies of FIGS. 1A and 1B. Assembly 80 has keeper 100 with C-shaped hook portion 101 that is configured to be engaged with C-shaped hook portion 111 of latch 110. Lower plate 102 is part of the keeper assembly. Latch portion 112 is meant to represent an over-center type latch of the type well known in the field. Lower plate 114 is part of the latch assembly. Opening 84 in portion 82 of the hollow body is for a bolt for the keeper and opening 88 in portion 86 of the hollow body is for a bolt for the latch. The bolts are not shown. Portions 82 and 86 are separated by space or joint 90. Gasket 104 is in hole 84 and gasket 116 is in hole 88.

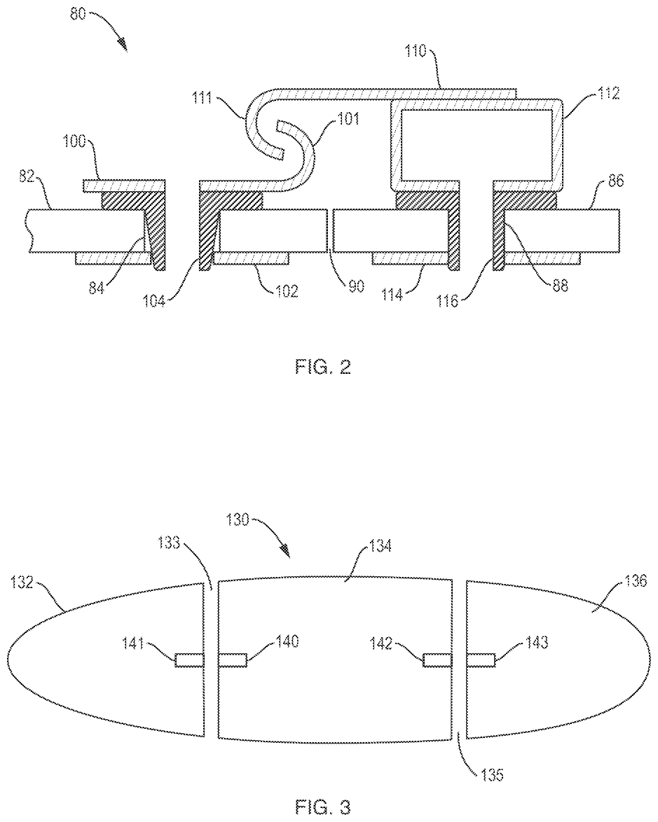

In some examples the hollow body is made of two or more separate portions that are coupled together before the hollow body is used. One non-limiting example is the stand-up paddleboard (SUP) disclosed in publication 2021/0394871, shown very schematically in FIG. 3. This SUP 130 is made of three hollow modules or portions 132, 134, and 136 that are interconnected by interior releasable latching mechanisms (not shown) that use a pin and receiving assembly arrangement, with the pin moved by a handle. The two joints 133 and 135 between the three modules can be stiffened by the use of releasable latch assemblies on the top and bottom surfaces, where the latch assemblies have a latch on one module and a receiver or keeper on the adjoining module. The latch can be an over-center latch of a type known in the latch field. In one example each latch is held in place with three bolts and each keeper is held in place with two bolts. In one specific non-limiting example there can be two of the latch/keeper assemblies on the top of the SUP, one for each of the two joints located in the middle of the joints (located in depressions 140/141 and 142/143 and the same arrangement on the bottom (one in the middle of each of the two joints, not shown). Thus, four in total, meaning twenty holes drilled into an otherwise water-tight molded module. Each of these holes can be made liquid tight using the gasket assemblies disclosed herein.

Having described above several aspects of at least one example, it is to be appreciated that various alterations, modifications, and improvements will readily occur to those skilled in the art. Such alterations, modifications, and improvements are intended to be part of this disclosure and are intended to be within the scope of the invention. Accordingly, the foregoing description and drawings are by way of example only, and the scope of the invention should be determined from proper construction of the appended claims, and their equivalents.

What is claimed is:

1. A liquid tight gasket assembly for use in creating a liquid tight seal for one or more fasteners that pass through holes in a hollow body, the liquid tight gasket assembly comprising:
an outside plate configured to be attached to one side of the hollow body and having one or more holes configured to allow fasteners to pass through;
a conformable gasket that is generally flat on top with a truncated cone on the bottom, wherein the gasket has a central opening with a diameter slightly smaller than a diameter of a stem of the fastener to pass through it, wherein the cone has a height that is longer than the thickness of the hollow body at the hole where the cone is inserted, and wherein the cone has a largest diameter that is greater than the diameter of the hole where the cone is inserted, so that the gasket does not enter the hole completely without a deforming force being applied;
an inside plate configured to be attached to a second side of the hollow body directly opposed to the outside plate and having one or more holes configured to allow fasteners to pass through;
fasteners with external male threads and having a stem diameter slightly larger than the diameter of the opening in the gasket;
wherein the fasteners are configured to pass through the outside plate, through the gasket center hole, and through the inside plate; and
nuts or other internally-threaded structures that are configured to be threaded onto the stem of a fastener protruding from the inside plate, wherein the action of threading the nuts or other internally-threaded structures firmly onto the stems exerts a compressing force between the outside and inside plates, thus forcing the cone completely inside the hole and against the stem, creating a liquid seal from the outside to the inside of the hollow body, and wherein the flat part of the gasket is compressed between the outside plate and the hollow body surface thus contributing to prevent liquid infiltration.

2. The liquid tight gasket assembly of claim 1, wherein the gasket is made of rubber or an elastomer.

3. The liquid tight gasket assembly of claim 1, wherein the hollow body comprises part of a watercraft.

4. The liquid tight gasket assembly of claim 1, wherein the hollow body comprises part of a stand up paddleboard.

5. The liquid tight gasket assembly of claim 1, wherein the outside plate comprises the base of a latch.

6. The liquid tight gasket assembly of claim 1, wherein the outside plate comprises the base of a keeper.

7. A standup paddleboard, comprising:
a plurality of separate hollow body portions that are configured to be interconnected by interior releasable latching mechanisms, creating two joints between the three portions;
at least one releasable latch assembly on each of the top and bottom surfaces, where the latch assemblies have a latch on one portion and a receiver or keeper on the adjoining portion, wherein the latch assemblies are coupled to the portions with threaded fasteners that pass through a surface of a portion and into the hollow interior;
each latch assembly comprising:
an outside plate configured to be attached to one side of the hollow body and having one or more holes configured to allow fasteners to pass through;
a conformable gasket that is generally flat on top with a truncated cone on the bottom, wherein the gasket has a central opening with a diameter slightly smaller than a diameter of a stem of the fastener to pass through it, wherein the cone has a height that is longer than the thickness of the hollow body at the hole where the cone is inserted, and wherein the cone has a largest diameter that is greater than the diameter of the hole where the cone is inserted, so that the gasket does not enter the hole completely without a deforming force being applied;
an inside plate configured to be attached to a second side of the hollow body directly opposed to the outside plate and having one or more holes configured to allow fasteners to pass through;
fasteners with external male threads and having a stem diameter slightly larger than the diameter of the opening in the gasket;
wherein the fasteners are configured to pass through the outside plate, through the gasket center hole, and through the inside plate; and
nuts or other internally-threaded structures that are configured to be threaded onto the stem of a fastener protruding from the inside plate, wherein the action of threading the nuts or other internally-threaded structures firmly onto the stems exerts a compressing force between the outside and inside plates, thus forcing the cone completely inside the hole and against the stem, creating a liquid seal from the outside to the inside of the hollow body, and wherein the flat part of the gasket is compressed between the outside plate and the hollow body surface thus contributing to prevent liquid infiltration.

8. The standup paddleboard of claim 7, wherein the gasket is made of rubber or an elastomer.

9. The standup paddleboard of claim 7, wherein the hollow body comprises part of a watercraft.

10. The standup paddleboard of claim 7, wherein the hollow body comprises part of a stand up paddleboard.

11. The standup paddleboard of claim 7, wherein the outside plate comprises the base of a latch.

12. The standup paddleboard of claim 7, wherein the outside plate comprises the base of a keeper.
